(19) United States
(12) Patent Application Publication
(10) Pub. No.: US 2018/0321952 A1
(43) Pub. Date: Nov. 8, 2018

(54) SYSTEM AND METHOD FOR DEVICE PROGRAMMING USING FINITE STATE MACHINES

(71) Applicant: Kirio Inc., Lynnwood, WA (US)

(72) Inventors: Franck Rougier, Seattle, WA (US); Yesid Julian Ramos Martinez, Seattle, WA (US)

(21) Appl. No.: 15/972,030

(22) Filed: May 4, 2018

Related U.S. Application Data
(60) Provisional application No. 62/501,596, filed on May 4, 2017.

(51) Int. Cl. G06F 9/448; G06F 17/16; G05B 15/02; G06N 7/00

(52) U.S. Cl. CPC G06F 9/4498; G06N 7/00; G05B 15/02; G06F 17/16

(57) ABSTRACT

A virtual machine allows for the control of an automation network by utilizing finite state machines to model the device network and map commands to real-world devices. The finite state machines may be constructed utilizing information on transitions and state descriptions specified in a file, as well as logic descriptions.

### CROSS REFERENCE TO RELATED APPLICATIONS

This application claims the benefit of U.S. provisional patent application Ser. No. 62/501,596, filed on May 4, 2017, the contents of which are incorporated by reference herein in their entirety.

### BACKGROUND

With the advent of advanced computer-powered and networked household appliances and devices, there is a growing need to manage these disparate systems. This management is key to energy efficiency, convenience and security. Traditionally, this has been done for large buildings and in custom applications centered around multimedia. However, it is becoming mainstream and new challenges of management are now seen in residential and smaller commercial buildings.

These device management platforms are typically driven by a computer system. On this computer, a software application comprised of scripts or compiled programs run continuously. The plurality of programs takes actions based on events, schedules and other conditions to triggers specific actions on the connected devices or end-user notifications.

Some of these computer systems are to perform with these fixed algorithms without ever requiring modifications. The implemented algorithms are fixed in their behavior at inception. Naturally, the algorithms are able to modify their execution path as envisioned at creation by the designers. Finally, the various input parameters are fixed and limited by the design time choices; so are the outputs.

However, in the majority of cases, a mutable system is needed whereby the algorithms and their inner workings could be updated and changed. The changes may stem from a new environment, for example, where the number of inputs increased, or the controllable outputs decreased. Hence, the changes can be applied by modifying the actual computer code to befit a new requirement. Today, this is the state of the art for process control and the generally accepted approach to managing a system of systems.

The maintenance of such algorithms is manageable for specific projects by dedicated staff. However, it is less scalable for mass-market and varied implementation of the device and sensor networks. The work is extremely tedious as it is custom and specific to each building.

Additionally, average electrical tradesmen are not computer programmers whose skills are required to maintain or implement these algorithms. Even when a template script or program is provided, it requires considerable training for a skilled tradesman to acquire this analytical ability. Though attainable, it is uncommon and instead, these tradesmen rely on application specific Programmable Logic Controllers (PLC) to accomplish their automation tasks or forego management or automation.

This relates to Home and Building automation and Management Systems (BMS) including Supervisory Control and Data Acquisition Systems (SCADA), hereafter referred to as BMS.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an embodiment of a system for device programming and modeling using Finite State Machines 100

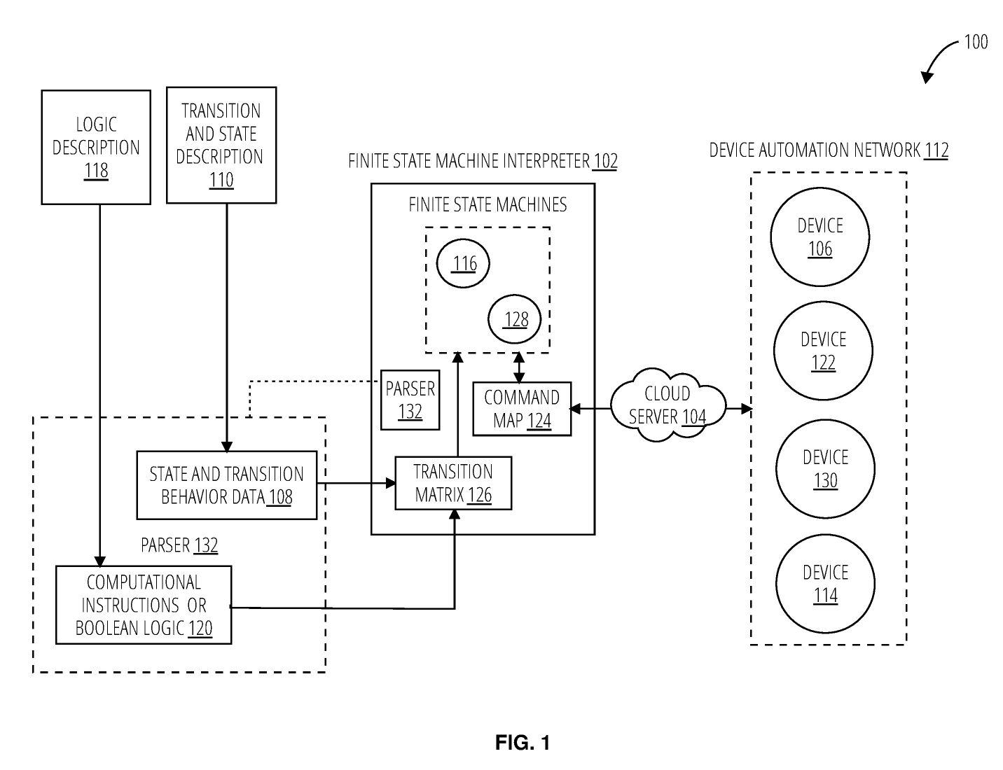

FIG. 2 illustrates a routine in accordance with one embodiment.

FIG. 3 illustrates an embodiment of a process 300.

FIG. 4 illustrates an embodiment of a finite state machine 400.

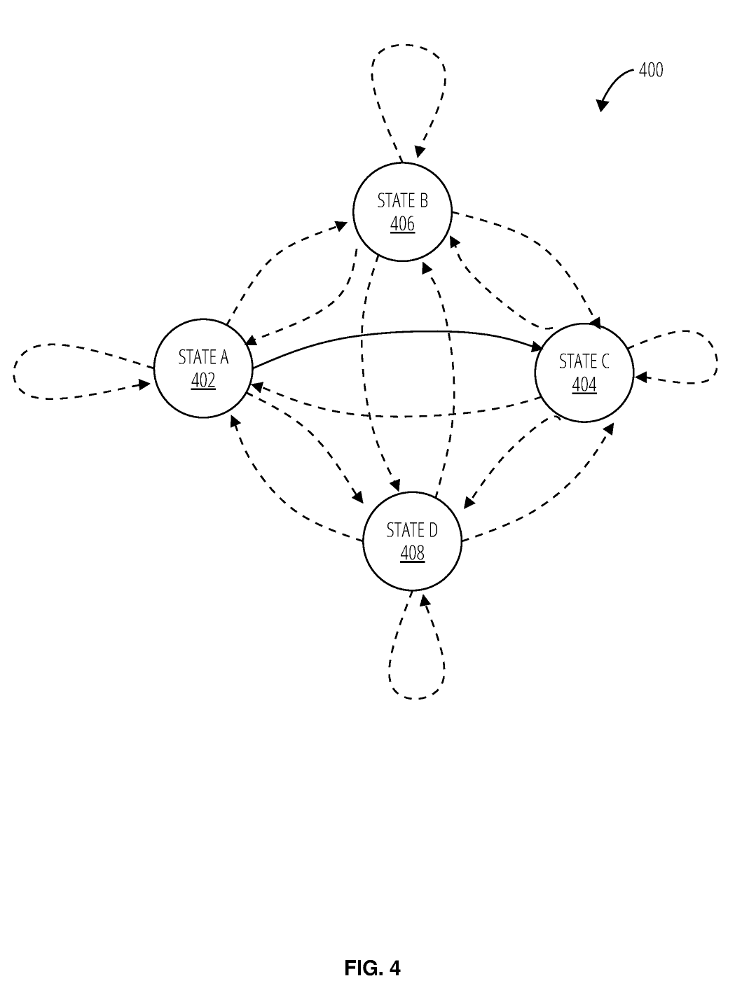

FIG. 5 illustrates an item 500 in accordance with one embodiment.

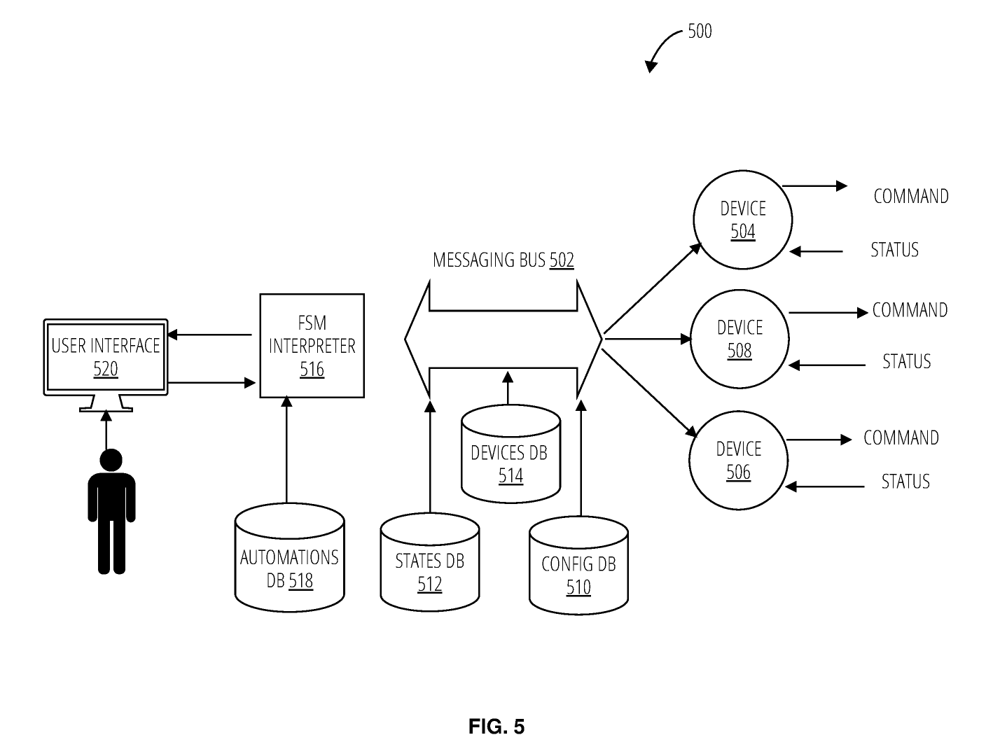

FIG. 6 illustrates a system 600 in accordance with one embodiment.

### DETAILED DESCRIPTION

The system and method herein described herein describes the programming of a computerized Building Management System (BMS) or other type of industrial, commercial or residential Process Control is changed from a script or literal computer program to a Finite State Machine (FSM) representation. A software-based FSM-Interpreter (FSMI) is then able to actualize a document-based specification to fulfill a particular FSM. This FSM-document is a textual representation of a state transition matrix where the individual states map to each of the available controls of managed devices.

Finite State Machines are well known computational models for those versed in the art. It is the recognition that control applications for system of systems can only reach finite states at any given time and that computer systems can only deal with discrete values. Even when these discrete value sets are very large, the cardinality is still finite and may be mapped directly to distinct states. In addition, when dealing with analog or time-continuous systems, the computer interfacing requires a discretization yielding still, finite and limited states.

The FSMI is a static computer application which implements an algorithm to load specifications (FSM), react to events, compute transformations and output commands. In itself, the FSMI is not responsible for directly managing the external devices and contains no particular predetermined actions for interacting with the former. The FSMI however interacts with a controller. It is useful to think of the FSMI as an abstracted computer that deals with states and transitions instead of discrete instructions to step through with working memory of current operations.

The controller may be a system which interacts with external devices under the BMS management. Its sole responsibility is to handle the intricacies of the communication protocol with the devices. It may implement a plurality of protocols and interact simultaneously with multiple devices and sensors. Devices and sensors might mean in some embodiment either real world devices such as thermostats and temperature sensors. And in others, virtualized devices representing higher abstractions such as an Internet-based music system or a weather service. Each of the available discrete control comprising the device or sensor (e.g. thermostat setpoint) is called an automation.

An automation can be of read-only, write-only and read-write types. Reading in this case means retrieving a sensor information (status update) and writing means sending a command (command). It is obvious that a sensor (e.g. barometer) cannot be written to according to the previous definition. In the same sense, an automation can be read to retrieve its current status and written to in order to command a desired effect (e.g. a dimmer). Finally, other automations can only be written to without the possibility of retrieving the current state (e.g. a relay). An automation may include other properties related to the actual device operation or process it abstracts. For example, a unit of measurement, the minimum and maximum values it can take, allowable increment/decrements and the command semantic required to execute the behavior in the target device.

The automation represents an attainable state by the controller hence by the device or sensor. Therefore, the FSMI can indirectly interact with the device or sensor via the controller. It is important to note that the controller only stores and retrieves states incoming from the devices and sensors. That is, on a command write, it is the real world or virtualized device or sensor which returns its current state. The command in itself does not represent the current device state. For devices which can only be written to, the controller allows an exception where the status update (read) is virtualized to represent the previously commanded state. This exception can cause a mismatch because of the lack of feedback loop. This is a common problem in open loop applications whereby the controller state is disconnected from physical reality. For example, a relay may receive a close signal from the controller but fail to close. The controller internal status update would show the relay as closed but the actual state of the relay will still be open. To address these conditions, a judicious system designer may use a sensor to find out if the relay-controlled motor, for example, is spinning by attaching an optical encoder. This encoder is a sensor represented in the controller as an automation and in the FSMI as a state. Hence, there is a closed loop system where the state of the motor (the device) would be represented by 2 automations related to activation and its status.

All events occurring within the realm of the controller and the panoply of attached devices and sensors are referred to as external events. They are considered external because in the BMS control system, they represent the outputs and the feedback loop sensing elements. Events occurring within the FSMI or manual adjustments made by the operator are referred to as internal events, because they represent the inputs to the BMS control system.

The FSMI communicates with the controller by subscribing to a particular named automation. Both the FSMI and the controller share a common database of available named automations (automation ID) such that the FSM states relate to the proper automation. Only 2 events are possible as they indicate data ingress and egress. The ingress data to the FSMI is called onUpdate and indicates that the controller read a new value for a particular external automation ID after performing a status update. The other event is the egress data from the FSMI called onCommand and it relates to a command issued to the controller for execution of a particular automation ID related to an external device. The onUpdate and onCommand are asynchronous triggered events which the FSMI responds to.

The FSMI may implement its own internal synchronous and blocking events for states which do not relate to any automations. Those special states and events include but are not limited to timer states with timeOut events, schedule states with onAlarm events, or messaging states with onSent/onError events, etc. . . .

It is important to note that thought the states could be numerous for a given automation ID (a dimmer from 0% to 100% would have 101 states for the dimming automation), this added abstraction is useless since the point of our state machine is to capture a current value whichever it is, as a generic state representing all possible values for that automation. Hence, states are not called the set of potential values, rather the automation is the state which can hold any values. This gives the opportunity to have abstract states which are unmapped to any automation. That is to simply say that every automation must map 1-to-1 with a state, but a state does not need a matching automation. This useful feature allows for internal states related to timing, memory, scheduling and other internal minutiae without involving the controller. Remember that to the exception of write-only automations, the controller is memoryless and only generates events based on-current data from external devices and sensors.

The controller can of course have a virtualized timer which would implement for example a timer automation. The timer countdown could be written to (set timer to 60 seconds) and read by the controller continuously and the FSMI would receive onUpdate events during the countdown. The particular FSM may have a transition condition at automation (e.g. state) equal to 0 second ordering it to move to another state. However, such implementation adds to the complexity of the FSM document. Therefore, these basic internal states are available within the FSMI without relying on virtualized devices serving this particular need.

In addition, the FSMI has the built-in ability to evaluate mathematical expressions, mapping, Boolean logic and other common state transition artifacts and state value modifiers. The underlying computer processor is used to perform such common operations though other operations can be created as their own FSM documents and included in other FMS implementations.

The FSMI enters a given state if the transition event and condition match the current event triggered asynchronously (internally or externally) and synchronously (within itself). Therefore, every state must specify the next state or a collection of next states whenever a transition is specified. If, the state is a final state, a null next state with no transition must be specified. Following is a discussion on the basic construct of the FSMI event triggering process.

Responding to the onUpdate event from a particular automation, the FSMI looks up the next state property of any current state which needs to transition and applies the specified action (if any) to the automation state (value) and immediately issues an onNotify event with this new state value. The default FSM if none is provided for this automation is sent as is with the onNotify event.

Internal state modification by the operator or any internal process will issue the onChange event for a particular automation. This causes the FSMI to respond with a transition to the specified new state(s) if the conditions permit, applying again any action specified to the current state value and immediately issuing an OnCommand event to the controller. The default FSM, if none is specified for the automation, the value is sent as is with the onCommand event.

Self FSMI generated events which have no automation specified do not issue any internal or external events (onNotify or onCommand). Rather, the FSMI attends within its realm to its own events following the same state transition, condition checks and applying any action if any.

### FSM-Interpreter Algorithm:

1—When the FSMI is started or when new FSM is added to the database, it loads from the FSM database
2—For all the defined states, loads the related automations
3—For each automation ID with onChange event property, store in onChange array
4—For each automation ID with onUpdate event property, store in onUpdate array
5—For all states with no automation ID, load default FSM
6—Connect to the controller and request event subscriptions for all the automation IDs present in the onChange array
7—while(true), Wait for event
8—onChange event (operator sending a command)
   a—Look up which automation ID triggered the onChange event inside the onChange array
   b—Look up next states to transition to
   c—If condition is true, using the current state value, apply action as directed to the state value
      (Multiple transitions can be activated at the same time within 1 FSM and multiple transition across the plurality of FSM's can also take place)
   d—For each state that is transitioning
      I. Transition to state
      II. If the new state contains a related automation ID, immediately issue an onCommand event to controller and pass computed new value
      III. If the new state does not contain a related automation ID, treat this state as described by the action
      IV. Loop d—
   e—Goto Wait for event
9—onUpdate event (operator/internal process sending a command)
   a—Look up which automation ID triggered the onUpdate event inside the onUpdate array
   b—Look up next states to transition to
   c—If condition is true, using the current state value, apply action as directed to the state value
      (Multiple transitions can be activated at the same time within 1 FSM and multiple transition across the plurality of FSM's can also take place)
   d—For each state that is transitioning
      I. Transition to state
      II. If the new state contains a related automation ID, immediately issue an onNotify event to operator/internal process, pass computed new value.
      III. If the new state does not contain a related automation ID, treat this state as described by the action.
      IV. Loop d—
   e—Goto Wait for event
10—onTimeout . . . event (Treatment of internal events such as onTimeout, onAlarm, onSent, onError . . . )
   a—Look up next state to transition to
   b—If condition is true, using the current state value, apply action as directed to the state value
      (Multiple transitions can be activated at the same time within 1 FSM and multiple transition across the plurality of FSM's can also take place)
   c—For each state that is transitioning
      I. If new state contains a related automation ID and its event trigger is onChange, immediately issue an onCommand to controller, pass computed new value
      II. If new state contains a related automation ID and its event trigger is onUpdate, immediately issue an onNotify to operator/process, pass computed new value
      III. If new state is not related to an automation ID, treat this state as described by the action
      IV. Loop c—
   d—Goto Wait for event
11—End

The FSM document is a state and transition description file which can be encoded in a variety of ways. By way of example, JavaScript Object Notation (JSON) format describing an FSM for a particular heating system. This system has a set point which accepts the new temperature in Celsius * 10. That is, if my comfort temperature is 25 degrees Celsius, this particular heating device needs the set point to be 250. However, the operator display device shows and sends the set point information in proper Celsius. An operator would like to be notified by email message whenever someone changes the temperature externally on the device after 60 seconds. A literal computer program can be written, compiled and run on a traditional BMS computer system. But if the new requirement is a different wait time for the notification or if the temperature set point conversion is different, a new program will have to be redesigned and compiled. However, this state machine can be updated as a document and inserted in the database. It is also possible to create this document automatically from a template or a pre-populated list stored in the BMS application without requiring the operator to modify any part of the FSM. Additionally, an FSM can be linked to the profile of this particular heating system and made available whenever the controller is using this device.

```
{ “id”: “12345”,
  “name”: “Temperature FSM”,
  “description”: “This FSM converts the temperature from
  a system which only understands as input Celsius*10 and a display in
  only Celsius. The user would like to be emailed 60s after an adjustment
  of the setpoint automation”,
  “version”: “1.0”,
  “states”: [
    “Converted”: {
      “automation”: “SetPoint”,
      “transition”: [{
        “trigger”: “onUpdate”,
        “condition”: null,
        “nextState”: “Raw”,
        “action”: {
          “type”: “transform”,
          “eval”: “Converted/10”
        }
      }]
    },
    “Raw”: {
      “automation”: “SetPoint”,
      “transition”: [{
        “trigger”: “onChange”,
        “condition”: null,
        “nextState”: [“Converted”, “WaitState”],
        “action”: {
          “type”: “transform”,
          “eval”: “Raw*10”
        }
      }]
    },
    “WaitState”: {
      “automation”: null,
      “transition”: [{
        “trigger”: “onChange”,
        “condition”: null,
        “nextState”: “Email”,
        “action”: {
          “type”: “timer”,
          “value”: 60
        }
      }]
    },
    “Email”: {
      “automation”: null,
      “transition”: [{
        “trigger”: “onTimeout”,
        “condition”: null,
        “nextState”: null,
        “action”: {
          “type”: “message”,
          “value”: “user changed the setpoint”
        }
      }]
    }
  ]
}
```

In the format, each state is named with the opening object. This name acts like a variable where you can retrieve the automation value. Every state must have an alphanumerical name. Numerical names are not permitted due to confusion during mathematical operations. Each sate then defines the automation property which is the named shared with the controller. The transition property defines the object for state transition. The trigger property is the event activator for this state transition and can be combined with other conditional to either allow or disallow the transition. The nextState property indicates which state the transition should move to. The action property allows multiple types and allows assignment of a value to the state upon transition. Obviously, other properties may be defined to extend this basic example format.

The previous example defines 4 states called “Converted” (holds the Celsius value), “Raw” (holds the Celsius*10 value), “WaitState” (a 60 second internal state) and “Email” state for sending an email.

The FSMI loads this document and implements the FSMI algorithm. There is no starting state and the next attained state will be dictated by the next event. Let's say that the user enters a new set point directly on the external heating device to 28 degrees Celsius. The controller drivers on its next refresh or when alerted by the set point change, reads 280 for the SetPoint automation and triggers the onUpdate event.

The FSMI responds by starting on the named state “Converted”, assigns the automation state value 280 to “Converted” and wants to move to the nextSate named “Raw”, with no conditions, it applies the transform action Converted/10=280/10=28 and transitions to state “Raw”, since “Raw” state contains a matching automation “SetPoint”, the FSMI sends an onNotify event to the internal process or BMS controller screen. The scree can now display the proper value 28 degree Celsius.

Conversely, if an operator of the BMS, sets the new set point automation value to 29 degrees Celsius, an internal event onChange is triggered. The FSMI enters “Raw” and “WaitSate” simultaneously, assigning the automation value 29 Celsius to “Raw” because it contains automation “SetPoint.” Processing in parallel, the “WaitState” starts a timer and blocks proceeding to the next state “Email” for 60 seconds and the “RawSate” not having any blocking conditions, proceeds to its nextState “Converted” while applying Raw*10=29*10=290. Since “Converted” state contains a matching automation “SetPoint” and responded to an onChange event, the FSMI triggers an onCommand passing the value 290 to the controller which ultimately relays it to the heater. When “WaitState” timer ends its countdown, it triggers within the FSMI a onTimeout event and finds the nextState “Email” with the onTimeout transition which creates an email to the desired person.

The system for device programming and modeling using Finite State Machines 100 comprises a finite state machine interpreter 102, a cloud server 104, a device 106, a transition and state description 110, a device automation network 112, a logic description 118, a device 122, and a finite state machine 128.

The device automation network 112 further comprises a device 130, a device 114, a device 106 and a device 122.

Finite state machine interpreter 102 further comprises a parser 132, command map 124, a transition matrix 126, a finite state machine 116 and a finite state machine 128. The parser 132 parses the state and transition behavior data 108 and the computational instructions or Boolean logic 120 from the transition and state description 110 and the logic description 118 respectively.

The logic description 118 further comprises a computational instructions or Boolean logic 120.

The transition and state description 110 further comprises a state and transition behavior data 108.

The device automation network 112 may comprise a home automation or IOT network. The device 106, the device 122, the device 130, and the device 114 may also comprise IOT or automation devices. In an exemplary embodiment, these may include climate control devices, lighting, and appliances. The device automation network 112 may be accessible through the cloud server 104. The finite state machine interpreter 102 may construct the finite state machine 116 and the finite state machine 128 utilizing the state and transition behavior data 108 and the computational instructions or Boolean logic 120 from the transition and state description 110 and the logic description 118 respectively. The finite state machine interpreter 102 may utilize the command map 124 to map specified states and transitions into sets of commands to operate or monitor the devices in the device automation network 112.

The system for device programming and modeling using Finite state Machines 100 may be operated in accordance with the process outlined in the process 300.

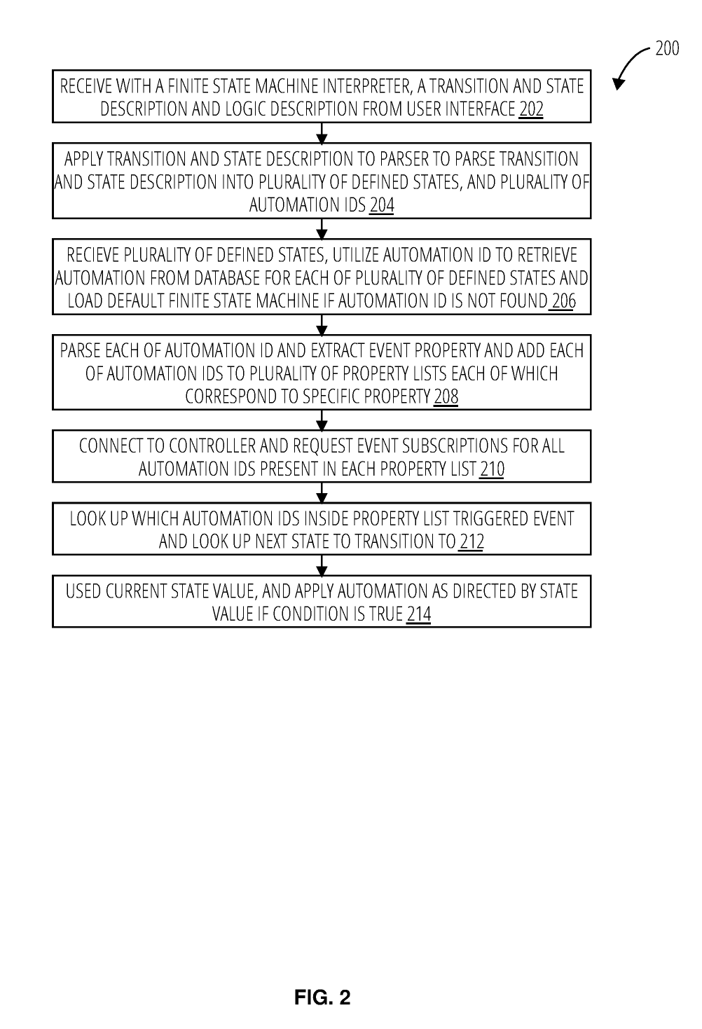

Referring to FIG. 2, the routine 200 the finite state machine interpreter receives a transition and state description and a logic description from a user interface (block 202).

The routine 200 applies the transition and state description to a parser to parse the transition and state description into a plurality of defined states, and a plurality of automation IDs (block 204).

The routine 200 recieves the plurality of defined states, utilizes the automation ID to retrieve an automation from a database for each of the plurality of defined states and loads a default finite state machine if the automation ID is not found (block 206).

The routine 200 parses each of the automation ID and extracts an event property and adds each of the automation IDs to a plurality of property lists each of which correspond to a specific property (block 208).

The routine 200 connects to a controller and requests event subscriptions for all the automation IDs present in each property list (block 210).

The routine 200 looks up which of the automation IDs inside the property list triggered an event and look up next state to transition to (block 212).

The routine 200 and uses a current state value, and applies an automation as directed by the state value if condition is true (block 214).

A finite state machine interpreter receives a transition and state description and a logic description from a user interface. The process then applies the transition and state description to a parser to parse the transition and state description into a plurality of defined states, and a plurality of automation IDs. The process then recieves the plurality of defined states, utilizes the automation ID to retrieve an automation from a database for each of the plurality of defined states and loads a default finite state machine if the automation ID is not found. The process then parses each automation ID and extracts an event property and adds each of the automation IDs to a plurality of property lists each of which correspond to a specific property. The process then connects to a controller and requests event subscriptions for all the automation IDs present in each property list. The process then looks up which of the automation IDs inside the property list triggered an event and look up next state to transition to. The process then and uses a current state value, and applies an automation as directed by the state value if condition is true.

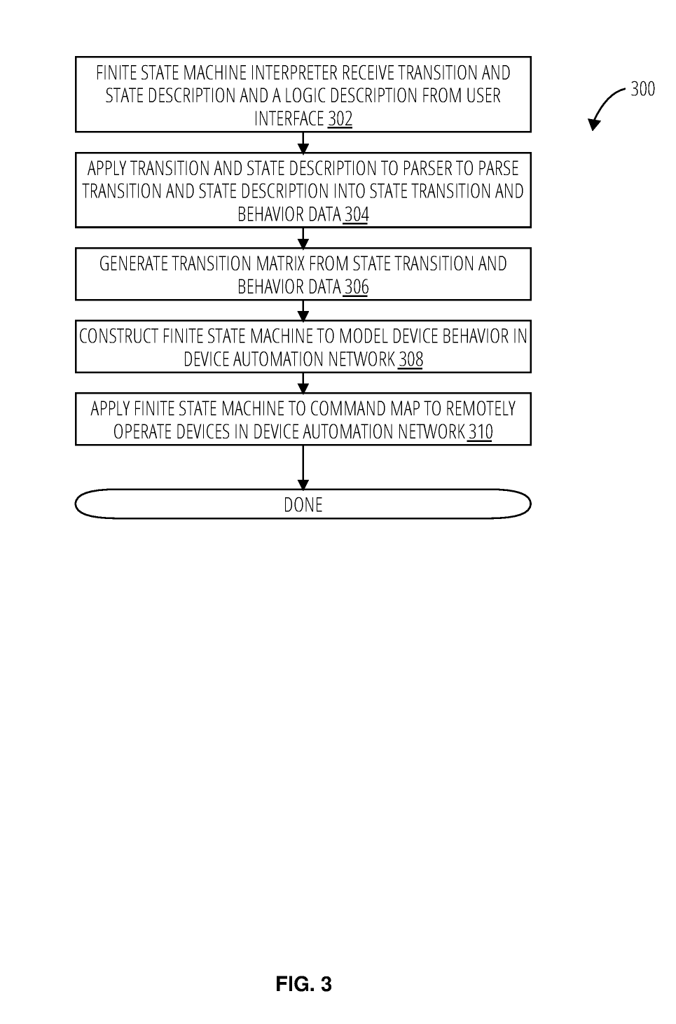

Referring to FIG. 3, the process 300 comprises:

A finite state machine interpreter receiving a transition and state description and a logic description from a user interface (block 302).

Applying the transition and state description to a parser to parse the transition and state description into state transition and behavior data. (block 304)

Generating a transition matrix from the state transition and behavior data. (block 306)

Constructing a finite state machine to model device behavior in a device automation network.

(block 308)

Applying the finite state machine to a command map to remotely operate devices in the device automation network. (block 310)

The finite state machine 400 comprises a state a 402, a state c 404, a state b 406, and a state d 408.

The finite state machine interpreter 102 may utilize a transition matrix 126 to model each possible transition between each possible state for each device. An exemplary device which had four states, may be modeled with a finite state machine 400 and may have 12 transitions captured by its transition matrix.

The item 500 comprises a messaging bus 502, a device 504, a device 506, a device 508, a config db 510, a state db 512, a devices db 514, a FSM interpreter 516, an automations db 518, and a user interface 520.

The FSM interpreter 516 receives transition and state descriptions and logic descriptions from the user interface 520, and automations from the automations db 518. The messaging bus 502 recieves commands from the FSM interpreter 516 and receives states from the states db 512, configurations from the config db 510 and devices from the devices db 514. The messaging bus 502 receives status updates from the device 508, the device 504, and the device 506 and returns it to the FSM interpreter 516.

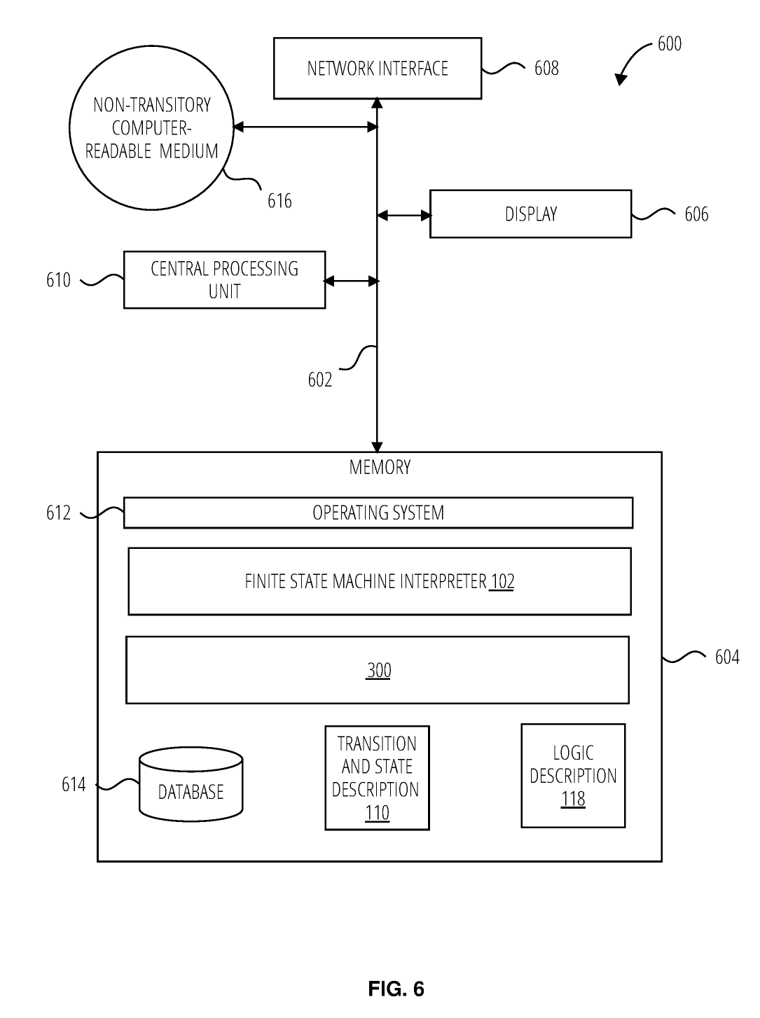

FIG. 6 illustrates several components of an exemplary system 600 in accordance with one embodiment. In various embodiments, system 600 may include a desktop PC, server, workstation, mobile phone, laptop, tablet, set-top box, appliance, or other computing device that is capable of performing operations such as those described herein. In some embodiments, system 600 may include many more components than those shown in FIG. 6. However, it is not necessary that all of these generally conventional components be shown in order to disclose an illustrative embodiment. Collectively, the various tangible components or a subset of the tangible components may be referred to herein as “logic” configured or adapted in a particular way, for example as logic configured or adapted with particular software or firmware.

In various embodiments, system 600 may comprise one or more physical and/or logical devices that collectively provide the functionalities described herein. In some embodiments, system 600 may comprise one or more replicated and/or distributed physical or logical devices.

In some embodiments, system 600 may comprise one or more computing resources provisioned from a “cloud computing” provider, for example, Amazon Elastic Compute Cloud (“Amazon EC2”), provided by Amazon.com, Inc. of Seattle, Wash.; Sun Cloud Compute Utility, provided by Sun Microsystems, Inc. of Santa Clara, Calif.; Windows Azure, provided by Microsoft Corporation of Redmond, Wash., and the like.

System 600 includes a bus 602 interconnecting several components including a network interface 608, a display 606, a central processing unit 610, and a memory 604.

Memory 604 generally comprises a random access memory (“RAM”) and permanent non-transitory mass storage device, such as a hard disk drive or solid-state drive. Memory 604 stores an operating system 612.

These and other software components may be loaded into memory 604 of system 600 using a drive mechanism (not shown) associated with a non-transitory computer-readable medium 616, such as a floppy disc, tape, DVD/CD-ROM drive, memory card, or the like.

Memory 604 also includes database 614. In some embodiments, system 600 may communicate with database 614 via network interface 608, a storage area network (“SAN”), a high-speed serial bus, and/or via the other suitable communication technology.

In some embodiments, database 614 may comprise one or more storage resources provisioned from a “cloud storage” provider, for example, Amazon Simple Storage Service (“Amazon S3”), provided by Amazon.com, Inc. of Seattle, Washington, Google Cloud Storage, provided by Google, Inc. of Mountain View, Calif., and the like.

What is claimed is:

1. A method comprising:
a finite state machine interpreter receiving a transition and state description and a logic description from a user interface;
applying the transition and state description to a parser to parse the transition and state description into state transition and behavior data;
generating a transition matrix from the state transition and behavior data;
constructing a finite state machine to model device behavior in a device automation network; and
applying the finite state machine to a command map to remotely operate devices in the device automation network.

2. The method of claim 1 wherein the the command map further comprises logic to translate communications with the device automation network and the finite state machine interpreter.

3. A computing apparatus, the computing apparatus comprising:
a processor; and
a memory storing instructions that, when executed by the processor, configure the apparatus to:
a finite state machine interpreter receiving a transition and state description and a logic description from a user interface;
apply the transition and state description to a parser to parse the transition and state description into state transition and behavior data;
generate a transition matrix from the state transition and behavior data;
construct a finite state machine to model device behavior in a device automation network; and
apply the finite state machine to a command map to remotely operate devices in the device automation network.

4. The computing apparatus of claim 3 wherein the the command map further comprises logic to translate communications with the device automation network and the finite state machine interpreter.
